(19) United States
(12) Patent Application Publication
(10) Pub. No.: US 2015/0070245 A1
(43) Pub. Date: Mar. 12, 2015

(54) COIL-BASED ARTIFICIAL ATOM FOR METAMATERIALS, METAMATERIAL COMPRISING THE ARTIFICIAL ATOM, AND DEVICE COMPRISING THE METAMATERIAL

(71) Applicants: SAMSUNG ELECTRONICS CO., LTD., Suwon-si (KR); CITY UNIVERSITY OF HONG KONG, Hong Kong (CN)

(72) Inventors: Seung-hoon Han, Seoul (KR); Jensen Tsan-Hang Li, Hong Kong (CN); Zixian Liang, Hong Kong (CN)

(73) Assignees: CITY UNIVERSITY OF HONG KONG, Hong Kong (CN); SAMSUNG ELECTRONICS CO., LTD., Suwon-si (KR)

(21) Appl. No.: 14/385,579

(22) PCT Filed: Mar. 15, 2013
(86) PCT No.: PCT/KR2013/002079

§ 371 Date: Oct. 17, 2014

Related U.S. Application Data
(60) Provisional application No. 61/611,672, filed on Mar. 16, 2012.

(30) Foreign Application Priority Data
Feb. 22, 2013 (KR) 10-2013-0019372

(51) Int. Cl. H01Q 15/02

(52) U.S. Cl. CPC H01Q 15/02
USPC 343/909

(57) ABSTRACT

Provided are an artificial atom of a metamaterial by coiling up space, a metamaterial including the artificial element, and a device including the metamaterial. The artificial atom of the metamaterial by coiling up space includes a first coiling unit that coils up a first space and a second coiling unit that coils up a second space and that is connected with the first coiling unit.

### TECHNICAL FIELD

The present disclosure relates to artificial atoms by coiling up space, metamaterials structured by an array of the artificial atoms, and devices including the metamaterials structured by an array of the artificial atoms.

### BACKGROUND ART

Metamaterials are artificial materials engineered to include at least one artificial atom unit that is patterned in a random size and shape smaller than the wavelength, wherein the metamaterials are structured by an array of the artificial atom units. Each of the artificial atom units included in the metamaterials exhibits predetermined properties in response to electromagnetic waves or acoustic waves applied to the metamaterials.

Consequently, metamaterials may be provided to have any effective refractive index and effective material coefficient that are not readily observed in nature with regard to electromagnetic waves or acoustic waves. Thereby, the metamaterials give rise to many novel phenomena including subwavelength focusing, negative refraction, extraordinary transmission, invisibility cloaking, or the like.

Phenomena caused by the metamaterials also occur in photonic or phononic crystals. However, in this case, the phenomena with regard to the photonic or phononic crystals occur only near the diffraction region where operating frequencies are high. It is hard to expect an application using the effective material coefficient. That is, the size of an artificial atom is constrained not to be sufficiently small in comparison with the wavelength.

### DETAILED DESCRIPTION OF THE INVENTION

### Technical Problem

Provided are a coiling artificial atoms.

Provided are metamaterials including the artificial atoms.

Provided are devices including the metamaterials.

### Technical Solution

According to an aspect of the present inventive concept, an artificial atom by coiling up space includes a first coiling unit that coils up a first space; and a second coiling unit that coils up a second space and that is connected with the first coiling unit.

At least one of the first and second coiling units may propagate incident waves along a zigzag path to be emitted.

Also, at least one of the first and second coiling units may be formed by connecting a plurality of channels in series where the incident waves propagate through.

Wave propagation directions of neighboring channels in the plurality of channels may be different.

Also, the neighboring channels of the plurality of channels may be separated by one plate.

The plurality of channels may be narrow in width in comparison to a wavelength of the wave.

The channel of the first coiling unit and the channel of the second coiling unit may be connected to each other in series.

The incident wave may be at least one of an acoustic wave, an electromagnetic wave, and an elastic wave.

Also, at least one of the first and second coiling units may coil up the space in at least one of two or three dimensions.

The first and second coiling units are rotationally symmetric about the point connecting the first and second coiling units to each other.

The first and second coiling units may be anisotropic.

Also, the first and second coiling units may be isotropic.

The artificial atom may also include a third coiling unit that coils up a third space and that is connected with the first and second coiling units, and a fourth coiling unit that coils up a fourth space and that is connected with the first to third coiling units.

The first to fourth coiling units may be interconnected to each other based on the center of the artificial atom.

Also, the artificial atom may be isotropic.

A refractive index of the artificial atom may be proportional to a length of the wave propagation in the artificial atom.

The refractive index of the artificial atom may be 4 or more.

At least one of an effective density and an effective bulk modulus of the artificial atom with regard to the wave of a specific frequency band may be negative.

Also, the refractive index of the artificial atom with regard to the wave of a specific frequency band may be negative.

A lattice constant of the artificial atom may be smaller than a wavelength of the wave.

The third and fourth coiling units may be rotationally symmetric about the point connecting the third and fourth coiling units to each other.

The artificial atom may further include a third coiling unit that coils up a third space and that is connected with the first and second coiling units, wherein the first to third coiling units are rotationally symmetric to each other about the center of the artificial atom, and effective wave propagation directions in each of the first to third coiling units may not exist in two dimensions.

Meanwhile, according to another aspect of the present inventive concept, a metamaterial may be formed by disposing a plurality of the artificial atoms, wherein the plurality of the artificial atoms may be formed in at least of the one dimension, two dimensions, and three dimensions.

According to another aspect of the present inventive concept, a device including the metamaterial may change characteristics of the incident wave.

According to another aspect of the present inventive concept, an artificial atom by coiling up space may include an inlet for an incident wave; an outlet for wave rejection; and a coiling unit 130 where space is coiled up and the waves move along a zigzag path toward the outlet.

In addition, the coiling unit may be formed by connecting a plurality of channels in series where the incident waves propagate through.

Also, a sum of the propagation directions of the plurality of channels may be consistent with the propagation directions from the inlet to the outlet.

A refractive index of the metamaterial structure may be proportional to a length of the pathway of the wave propagation in the coiling unit.

### Effects of the Present Invention

The characteristics of waves may be changed by a coiling artificial atom.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating an artificial atom by coiling up space, according to an embodiment of the present inventive concept;

FIG. 2A is a view illustrating a two-dimensional artificial atom, according to an embodiment of the present inventive concept, and FIG. 2B is a view illustrating a simplified coiling effect of the two-dimensional artificial atom of 2A;

FIG. 3A is a view illustrating a band structure of the two-dimensional artificial atom of FIG. 2A (illustrating a relationship between a frequency and a wave vector), and FIGS. 3B to 3D are views illustrating Equi-Frequency Contours (EFCs) of the first to third bands of FIG. 3A;

FIG. 4A is a graphical view illustrating relative effective refractive index (solid line) and relative effective impedance (dashed line), according to the frequency of the two-dimensional artificial atom of FIG. 2A. FIG. 4B is a graphical view illustrating effective density (solid line) and effective bulk modulus (dashed line), according to the frequency of the two-dimensional artificial atom of FIG. 2A;

FIG. 5 is a view schematically illustrating a three-dimensional artificial atom according to an embodiment of the present inventive concept;

FIG. 6 is a view illustrating a prism constructed using the same structures of the one-dimensional artificial atom shown in FIG. 1 and the two-dimensional artificial atom shown in FIG. 2.

FIG. 7A shows a result of a pattern simulation of a pressure field of waves when a solid plate blocking more than half of a width of a waveguide is inserted. FIG. 7B shows a result of a pattern simulation of a pressure field of waves when metamaterials, according to an embodiment of the present inventive concept, are disposed around the solid plate of FIG. 7A.

FIG. 8 is a view illustrating a lens formed of metamaterials according to an embodiment of the present inventive concept.

### BEST MODE

Hereinafter, the disclosed coiled artificial atom and a metamaterial and a device including the coiled artificial atom will be described in detail with reference to the accompanying drawings.

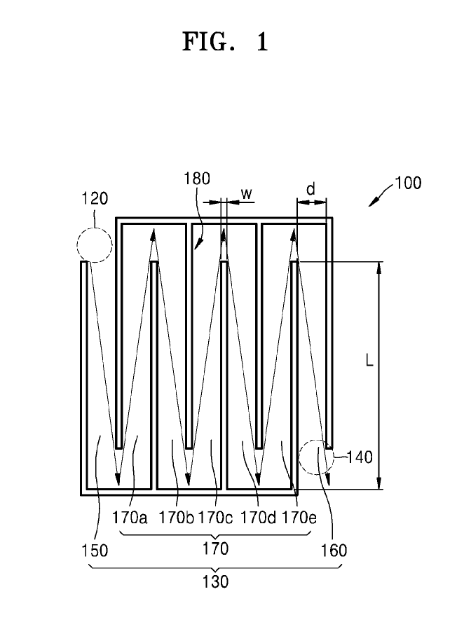

FIG. 1 is a view illustrating an artificial atom by coiling up space, according to an embodiment of the present inventive concept. Referring to FIG. 1, the artificial atom 100 includes an inlet 120 for an incident wave, an outlet 140 for wave rejection, and a coiling unit 130 where space is coiled up and the waves move along a zigzag path toward the outlet 140.

The incident waves in the artificial atom 100 may be acoustic waves. Acoustic waves may propagate within perforations of subwavelength cross sections in the absence of a cutoff frequency.

In addition, since an acoustic wave is simply a scalar field, these perforations may be further coiled up, whereas the waves may still propagate freely in the curled space.

The coiling unit 130 may coil up the space by connecting a plurality of channels in series, namely, an inlet channel 150, an output channel 160, and an intermediate channel 170. The wave propagation directions of neighboring channels may be different. However, a vector sum of the wave propagation directions in all the channels may be consistent with the wave propagation directions from the inlet 120 to the outlet 140. Also, the coiling unit 130 may coil up the space in two dimensions or three dimensions by a plurality of the channels.

For example, when the coiling unit 130 is formed of two channels, namely, the inlet channel 150 and the output channel 160, the coiling unit 130 may include the inlet channel 150 where one end thereof is connected with the inlet 120 to guide the wave propagation in a first direction, and the outlet channel 160 where one end thereof is connected with the outlet 140 to guide the wave propagation in a second direction. In addition, the coiling unit 130 may further include at least one intermediate channel 170 disposed between the inlet channel 150 and the output channel 160 to guide the wave propagation in a third direction.

The wave propagation directions of the neighboring channels may be different. However, a vector sum of the propagation directions of the waves in all the channels may be consistent with the wave propagation directions from the inlet 120 to the outlet 140. Herein, the wave propagation directions from the inlet 120 to the outlet 140 are referred to as effective wave propagation directions of the artificial atom 100. In particular, when the coiling unit 130 coils up the space in two dimensions, the wave propagation directions in odd-numbered channels based on the inlet 120 may be different from the wave propagation directions in even-numbered channels, whereas the wave propagation directions in the odd-numbered channels may be equal to each other and the wave propagation directions in the even-numbered channels may be equal to each other.

FIG. 1 illustrates the coiling unit 130 where the space is coiled up by 7 channels. In particular, the coiling unit 130 may include several types of channels: the inlet channel 150 that connects one end thereof with the inlet 120 to guide the wave propagation in a first direction, a first intermediate channel 170a that connects one end thereof with the inlet channel 150 to guide the wave propagation in a second direction, a second intermediate channel 170b that connects one end thereof with the first intermediate channel 170a to guide the wave propagation in a third direction, a third intermediate channel 170c that connects one end thereof with the second intermediate channel 170b to guide the wave propagation in a fourth direction, a fourth intermediate channel 170d that connects one end thereof with the third intermediate channel 170c to guide the wave propagation in a fifth direction, a fifth intermediate channel 170e that connects one end thereof with the fourth intermediate channel 170d to guide the wave propagation in a sixth direction, and the output channel 160 that connects one end thereof with the fifth intermediate channel 170e and the other end thereof with the output unit 140 to guide the wave propagation in a seventh direction. The odd-numbered channels (i.e., the inlet channel 150, the second intermediate channel 170b, the fourth intermediate channel 170d, and the output channel 160) have waves with the same propagation direction. The even-numbered channels (i.e., the first intermediate channel 170a, the third intermediate channel 170c, and the fifth intermediate channel 170e) have waves with the same propagation direction. Although the wave propagation direction in odd-numbered channels is different from the wave propagation direction in even-numbered channels, a vector sum of the propagation directions of all the channels is consistent with the effective wave propagation direction. The channels illustrated in FIG. 1 are just based on one embodiment of the present inventive concept, and the number of channels or a wave propagation direction therein may vary depending on characteristics of the artificial atom 100. That is, a coiling degree or the like of a coiling unit may vary depending on the purpose to change the characteristics of waves. Herein, a coiling degree of a coiling unit may be determined by the number of channels changing wave propagation directions, that is, the number of changes in the wave propagation directions or a total distance of the wave propagation.

In the artificial atom 100, when a straight distance between the inlet 120 and the output unit 140 is referred to as a lattice constant a, a width d of the channels may be smaller than the lattice constant a and also may be narrower than a wavelength of the waves. For example, the width d of the channel may be 0.081 times of the lattice constant a.

The waves propagating in the coiling unit 130 may propagate along a zigzag path so that the incident waves in the artificial atom 100 may be able to propagate a longer distance than the lattice constant a. For example, a length of the pathway of the waves formed by the coiling unit 130 may be 4.2 times or longer than a lattice constant a.

In addition, in order to minimize a volume of the artificial atom 100, the neighboring channels in the plurality of channels may be separated by one plate 180 and the plate 180 may be in the form of a narrow thin film. The plate 180 may be formed of a solid material such as metal like brass or polymer. A length L of the plate 180 may be shorter than a lattice constant a. For example, the length L of the plate 180 may be 0.61 times the lattice constant a. In addition, it is desirable to have a narrow plate in width in comparison to the lattice constant a. For example, the width of the plate 180 may be 0.02 times the lattice constant a.

The artificial atom 100 illustrated in FIG. 1 may include one coiling unit and accordingly, waves such as acoustic waves or electromagnetic waves may have one effective wave propagation direction via the artificial atom 100. Therefore, the artificial atom 100 illustrated in FIG. 1 may be referred as a one-dimensional artificial atom. Such one-dimensional artificial atoms may be disposed to form a metamaterial. The one-dimensional artificial atoms may be disposed in one, two, or three dimensions. Depending on the form of an array of one-dimensional artificial atoms, a metamaterial emits the incident waves by changing the characteristics of the waves.

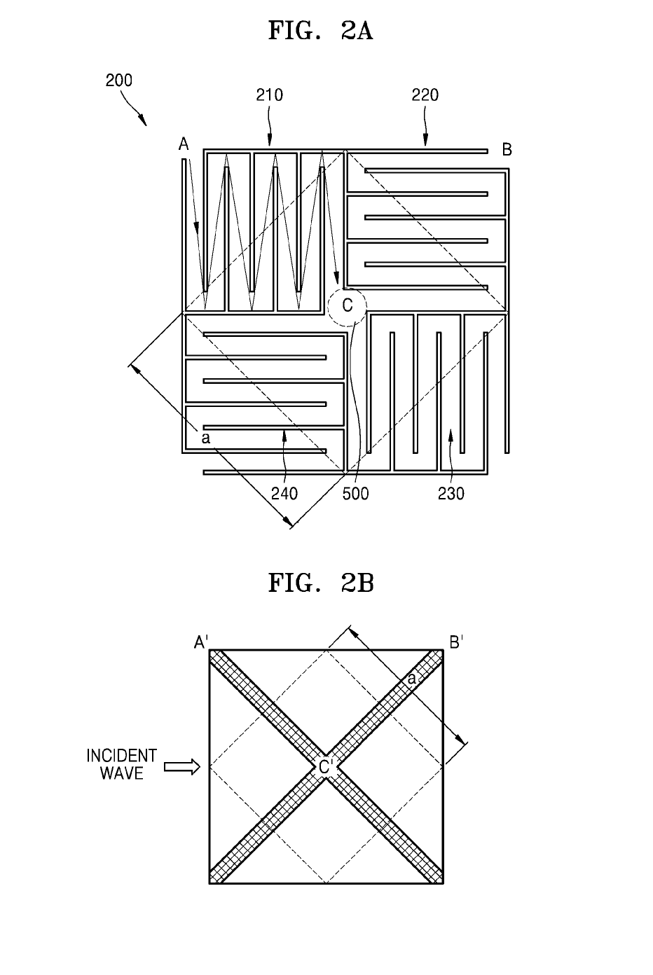

Also, the artificial atoms in the metamaterial may include a plurality of coiling units, wherein wave propagation directions are different. FIG. 2A is a view illustrating a two-dimensional artificial atom, according to an embodiment of the present inventive concept. As shown in FIG. 2A, a two-dimensional artificial atom 200 may be formed by connecting a plurality of coiling units having different effective wave propagation directions in the two-dimensional plane.

For convenience of description, FIG. 2A illustrates 4 coiling units 210, 220, 230, and 240 that are interconnected to each other. However, the two-dimensional artificial atom is not limited thereto, and may be formed by connecting at least 2 coiling units. For convenience of description, it will be described about changes in the characteristics of the waves in the case of 4 interconnected coiling units.

As described above, each of coiling units 210, 220, 230, and 240 coils up the space, and thus the waves propagate along a zigzag path. The coiling units 210. 220. 230, and 240 may coil up the space in two or three dimensions.

One end of each of the coiling units, namely first, second, third, and fourth coiling units 210, 220, 230, and 240, is disposed at the center c of the two-dimensional artificial atom 200 to be interconnected to each other. The first, second, third, and fourth coiling units 210, 220, 230, and 240 may be disposed to be rotationally symmetric about the center point c.

For example, the first to the fourth coiling units 210, 220, 230, and 240 may be disposed in a way the first coiling unit 210 corresponds to the second coiling unit 220 if rotated 90° relative to the center point c. Likewise, the second coiling unit 220 corresponds to the third coiling unit 230 if rotated 90° relative to the center point c, and the third coiling unit 230 corresponds to the fourth coiling unit 240 if rotated 90° relative to the center point c. Also, the fourth coiling unit 240 corresponds to the first coiling unit 210 if rotated 90° relative to the center point c. Therefore, the first coiling unit 210 is diagonally symmetrical to the third coiling unit 230 about the center point c, and the second coiling unit 220 is diagonally symmetrical to the fourth coiling unit 240

Therefore, the effective propagation of waves in the first coiling unit 210 may be equal to that in the third coiling unit 230. Likewise, the effective propagation of waves in the second coiling unit 220 may be equal to that in the fourth coiling unit 240.

Thereby, the incident wave in the two-dimensional artificial atom 200 may be emitted to the outside of the artificial atom 200 via at least one of the 4 coiling units 210, 220, 230, and 240. For example, the incident waves coming from the outside of the artificial atom 200 through the first coiling unit 210 may propagate within the first coiling unit 210 and then may be dispersed from the center point c to the second, third, and fourth coiling units 220, 230, and 240. Accordingly, the dispersed waves may propagate within each coiling unit to then be emitted to the outside. Depending on the characteristics of the incident waves, the waves may be dispersed to all of the second, third, and fourth coiling units 220, 230, and 240, or may be dispersed to some of the coiling units 220, 230, and 240.

FIG. 2B is a view illustrating an evenly simplified channel formation to describe a coiling effect of the two-dimensional artificial atom of FIG. 2A. That is, the “X”-shaped region in FIG. 2B represents regions of the channels equivalent to the coiling channels, and the rest of the regions represents plates forming the channels. Herein, a refractive index n₀ᵣ in the “X”-shaped region of the channel may be defined by dividing the wave speed passing through the inlet of the coiling unit to the outlet of the coiling unit in the absence of the channels by the wave speed passing through the coiling unit from the inlet to the outlet. For example, when a length of the wave propagation by the coiling unit is 4.2 times the straight-line distance between the inlet and the outlet, the refractive index n₀ᵣ is 4.2. A high refractive index and an elapsed phase of the corresponding wave may be achieved by providing curvatures as much as desired on the channels. The metamaterial based on the artificial atom units by coiling up as may operate effectively without causing a diffraction effect for low-frequency acoustic waves. Therefore, a size of a device that controls acoustic waves may be reduced by using the corresponding metamaterial.

Hereinafter, the dispersion relations (i.e., the relationship between frequency and frequency vector) in the two-dimensional artificial atom 200 will be described. By applying the Floquet-Bloch theory, the dispersion relation may be approximately obtained as Equation 1 below.

COS Φ_{C′A′}+COS Φ_{C′B′}=2COS(nₒᵣ₂k₀a) <Equation 1>

where Φ_{C′A′} and Φ_{C′B′} represent the elapsed phase of a Bloch wave in the C′A′ and C′B′ directions, respectively in FIG. 2B. In Equation 1, k₀ represents the number of the acoustic waves, and nₒᵣ₂ represents the refractive index of the first and the second coiling units 210 and 220. The coiling units in the two-dimensional artificial unit show in FIG. 2A are rotationally symmetric about the center point c so that the refractive indices of the coiling units are consistent with each other.

Equation 1 represents the dispersion relation and the band folding. Since the two-dimensional artificial atom coils up the space with the same factor nₒᵣ in both the C′A′ and C′B′ directions, equi-frequency contours (EFCs) are very close to a circle near the Γ point (that is, COS Φ_{C′A′}=COS Φ_{C′B′}=0). This generates an isotropic refractive index for the two-dimensional artificial atom 200 of FIG. 2A. The normalized frequency ωa/(2πc) (where ω is each frequency of acoustic waves, c is acoustic wave speed in aft) at the Γ point may be found as integral multiples of 1/n₀ᵣ₂.

Therefore, the position of the band in the frequency range may be tuned by n₀ᵣ₂ or the path length of the acoustic waves in the coiling units. A longer path length is equivalent to a higher refractive index n₀ᵣ₂. This generates a formation of a two-dimensional artificial atom to have band folding at low enough frequencies, and the metamaterials formed of the two-dimensional artificial atom may be still described with both effective density and effective bulk modulus near the Γ point.

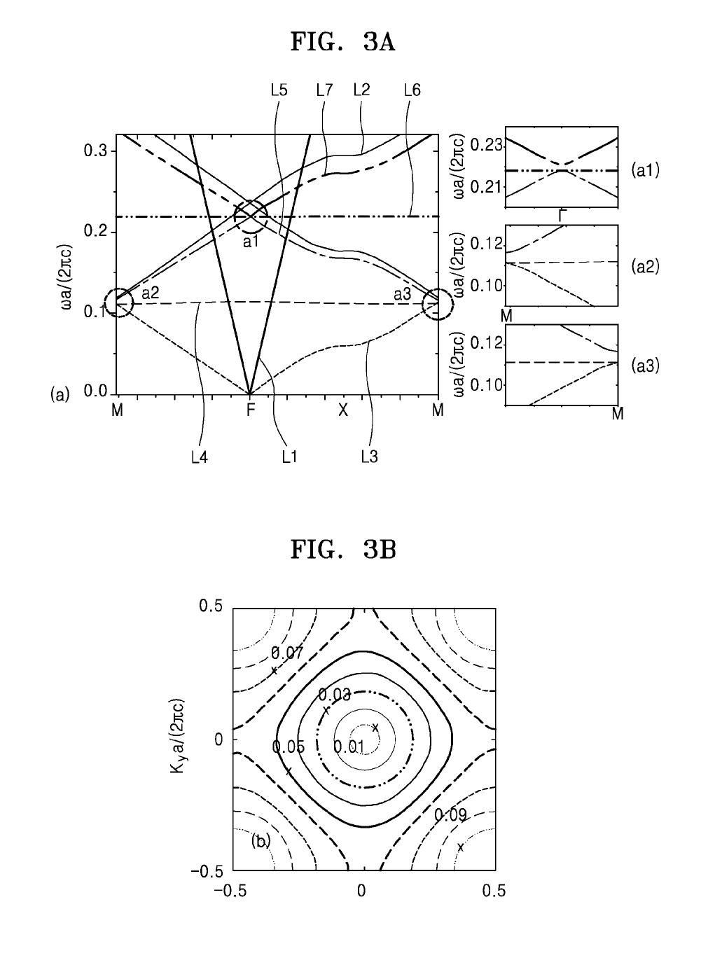

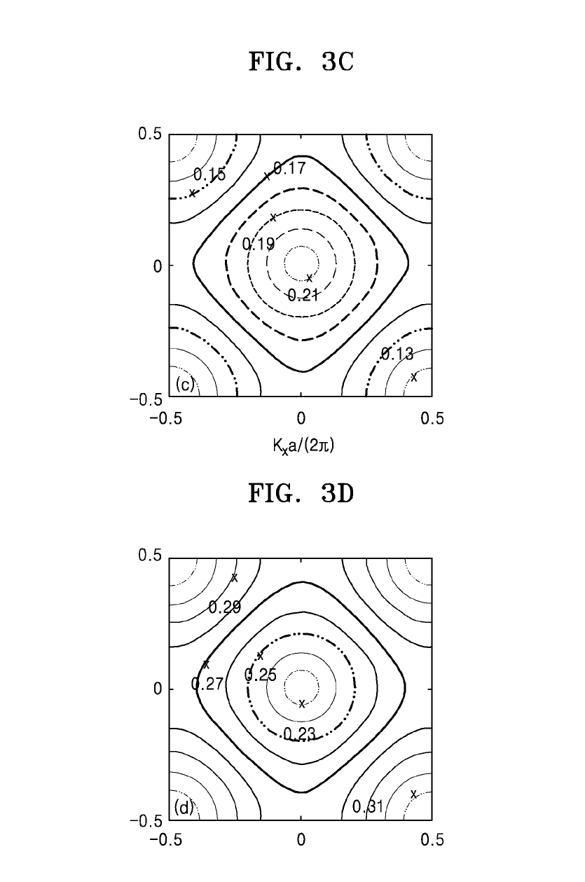

FIG. 3A is a view illustrating a band structure (the relationship between frequency and wave vector) of the two-dimensional artificial atom 200 of FIG. 2A, and FIG. 3B to 3D are views illustrating Equi-Frequency Contours (EFCs) of the first to third bands of FIG. 3A.

In FIG. 3A, a first solid line L1 represents characteristics of the wave in air, and a second solid line L2 represents a band structure of the two-dimensional artificial atom 200 obtained by Equation 1. Dashed curve lines L3 to L7 represent the results obtained numerically through DMS simulation. The first to the fifth bands L3 to L7 are formed from low frequency to high frequency. The slopes of the second and the fourth bands L4 and L6 near the frequencies 0.11 and 0.22 are flat to almost zero.

The Γ X direction of FIG. 3A corresponds to the CB direction of FIG. 2A. Except for a small frequency shift due to the finite width of the regions, which represent circles a1, a2, and a3 at the Γ X position, and of the channel within each coiling unit in the two-dimensional artificial atom, the band structure of the simulation is almost similar to the band structure of Equation 1. At lower frequencies, the channel width is much smaller than the wavelength, and thus it confirms that the two band structures, which are obtained by the simulation and Equation 1, coincide with each other. The slopes of the dispersion relations around the Γ point in both the ΓX and ΓM directions are almost the same at the first, third, and fifth bands L3, L5, and L6 owing to band folding. This indicates that the refractive index of the two-dimensional artificial atom is an isotropic index. Thus, it was confirmed that the three bands having frequencies ωa/(2πc) from 0 to 0.04, from 0.18 to 0.218, from 0.22 to 0.26 as illustrated in FIGS. 3B to 3D are almost circular with variations in radius within 5%. The different relative indexes may then be extracted from the size of the EFCs, comparing to the dispersion relations in the aft (black solid line).

At the third band L5, a negative refractive index from 0 to −1 may be obtained, and at the fifth band L7, a refractive index smaller than 1 may be obtained. There is a flat band around ωa/(2πc)=0.219 at the edge of the band gap. The mode of the acoustic waves in this flat band is transverse in nature. Thus, such modes may not be exited by incident plane waves of longitudinal modes.

In addition, by calculating the complex reflection and transmission coefficients of the two-dimensional artificial atom 200, the relative effective refractive index nᵣ and relative effective impedance Zᵣ of the above-mentioned bands may be calculated. Due to the lack of local resonance, material absorption losses are not amplified near the resonance frequency.

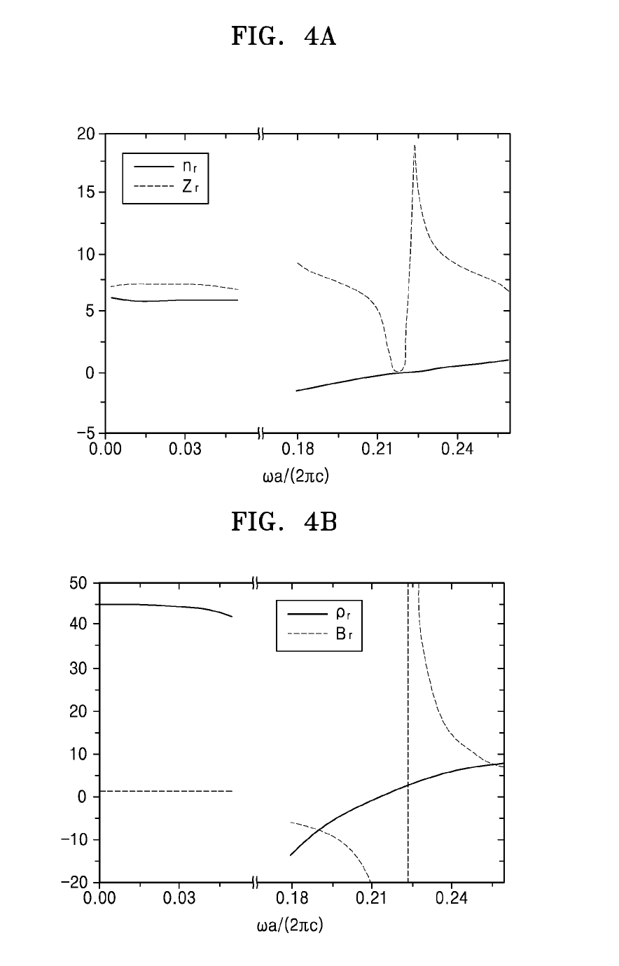

FIG. 4A is a graphical view illustrating relative effective refractive index (solid line) and relative effective impedance (dashed line), according to frequency of the two-dimensional artificial atom 200 of FIG. 2A. FIG. 4B is a graphical view illustrating effective density (solid line) and effective bulk modulus (dashed line), according to frequency of the two-dimensional artificial atom 200 of FIG. 2A. The relative effective index shown in FIG. 4A is the same as the relative effective refractive index shown in FIG. 3A. The effective density and effective bulk modulus shown in FIG. 4B may be obtained by ρᵣ=nᵣZᵣ and Bᵣ=Zᵣ/nᵣ, respectively.

At the low frequency region having longer wavelength compared to the lattice constant a of the artificial atom, ρᵣ and Bᵣ may simply be constants. For example, Bᵣ=1/(1−f)=1.23 where f=0.19 is the filling ratio (FR), and the relative effective density ρᵣ=nᵣ²Bᵣ=44.3 when nᵣ=6 is obtained. The two-dimensional artificial atom disclosed in the present specification is effective at achieving a high refractive index which is rare in nature. For example, when the frequency range is from 0.18 to 0.26, ρᵣ changes from negative to positive and crosses zero at ωa/(2πc)=0.218, which is the lower edge of the band gap. Meanwhile. 1/Bᵣ also changes from negative to positive in a similar way and crosses zero at ωa/(2πc)=0.22, which is the upper edge of the band gap. Below the band gap, there is a frequency region of all negative ρᵣ, Bᵣ, and nᵣ at the same time. In order to have both negative ρᵣ and Bᵣ at the same time (double negative), contrary to the conventional approaches in overlapping two different kinds of resonances to create double negativity, the space is coiled up to give a large enough n₀ᵣ.

In FIG. 2A, a two-dimensional artificial atom is formed of 4 rotationally symmetric coiling units, but a two-dimensional artificial atom is not limited thereto. For example, it is also possible to form a two-dimensional artificial atom by 2 rotationally symmetric coiling units. In addition, a two-dimensional artificial atom may be formed of a plurality of coiling units that are not symmetric or that have different coiling degrees. That is, anisotropy coiling units may be combined to form a two-dimensional artificial atom. A disposition relation between coiling units or a degree of each coiling unit may vary depending on the purpose of changing the characteristics of the waves. That is, a disposition relation between coiling units or a degree of each coiling unit may vary material coefficients (i.e., refractive index, impedance, modulus, density, etc).

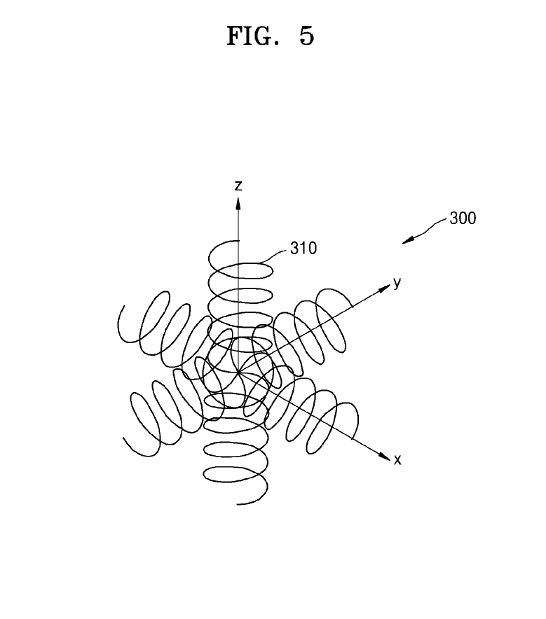

FIG. 5 is a view schematically illustrating a three-dimensional artificial atom according to an embodiment of the present inventive concept.

A three-dimensional artificial atom 300 may be formed by connecting a plurality of coiling units 310 in three dimensions in which each coiling unit has different effective wave propagation. In FIG. 5, the curves represent the coiling units. For example, 6 coiling units 310 may be interconnected to each other to form the three-dimensional artificial atom 300. The coiling units 310 may coil up the space in two or three dimensions.

Each coiling unit 310 is connected with the center of the artificial atom 300, and each coiling unit may be corresponded to a neighboring coiling unit when rotated 90° relative to the center point. Also, the effective wave propagation directions of each coiling unit 310 may not exist in the two-dimensional plane. As described above, the disposition relation between coiling units or a degree of each coiling unit may vary depending on the purpose of changing the characteristics of the waves.

A metamaterial may be formed by disposing the above-described artificial atoms. In detail, a metamaterial may be formed by disposing one-dimensional artificial atoms in one dimension, two dimensions, or three dimensions, or by disposing two-dimensional artificial atoms in one dimension, two dimensions, or three dimensions. Likewise, a metamaterial may be formed by disposing three-dimensional artificial atoms in one dimension, two dimensions, or three dimensions. In addition, a metamaterial may be formed by connecting at least two of the one-dimensional, two-dimensional, and three-dimensional artificial atoms and then disposing them in one dimension, two dimensions, or three dimensions.

A metamaterial may be isotropic or anisotropic by adjusting a degree of coiling units included in the artificial atom. When the coiling units coil up the space and the metamaterial has a high refractive index, the artificial atom may operate at frequencies having low effective density and low volume modulus. Thus, a metamaterial may reduce the loss of the waves in comparison with conventional metamaterial using local resonance to obtain a double negativity, an effective density close to zero, and a positive refractive index. Also, a device that changes the characteristics of the waves by the metamaterial of the present inventive concept may be manufactured.

For example, an acoustic prism that has negative effective density and negative effective bulk modulus may be constructed using the metamaterial.

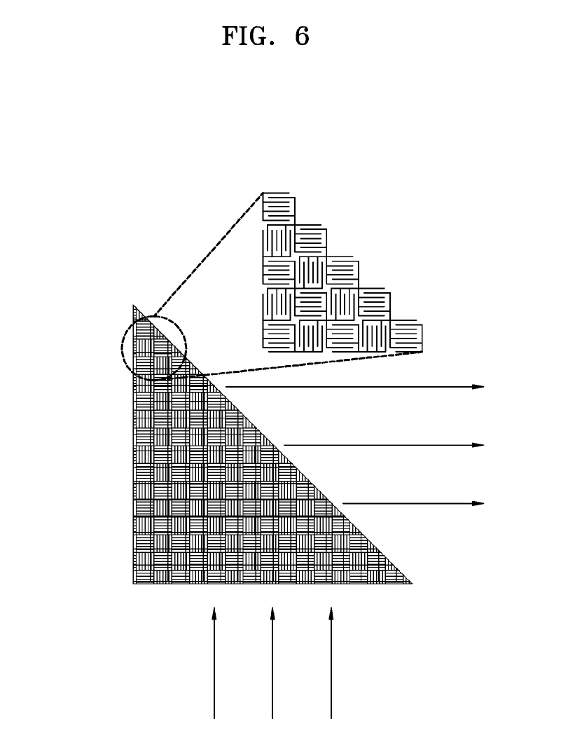

FIG. 6 is a view illustrating a prism constructed using the same structures of the one-dimensional artificial atom shown in FIG. 1 and the two-dimensional artificial atom shown in FIG. 2. As illustrated in FIG. 6, a prism with an angle of inclination of 45° may be formed by disposing the one-dimensional and two-dimensional artificial atoms in two dimensions. Then, an acoustic beam with an amplitude distribution in the form of a Gaussian beam of width 15.4 a with a chosen normalized frequency ωa/(2πc)=0.191 in a vacuum enters from the bottom of the prism. The two-dimensional artificial atom has a relative effective refractive index nᵣ=−1 at the normalized frequency so that the beam undergoes negative refraction and exits the prism.

As another example, an artificial atom may have a density near to zero at a very low frequency as described above. Thus, when metamaterials formed of the artificial atoms are disposed within a waveguide, waves may cause a tunneling phenomenon within the waveguide.

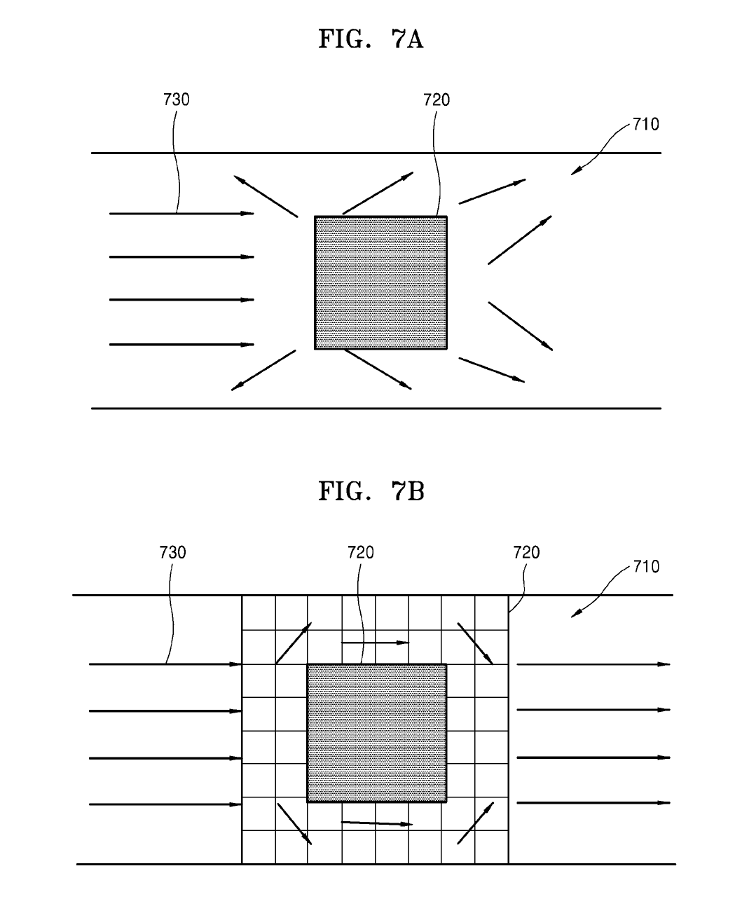

FIG. 7A is shows a result of a pattern simulation of a pressure field of waves when a solid plate blocking more than half of a width of a waveguide is inserted. As illustrated in FIG. 7A, a solid plate 720 is inserted in the middle of a waveguide 710, and plane acoustic waves 730 enter from left to right of the waveguide 710. Because the solid plate 720 blocks more than half of the width of the waveguide 710, the plane acoustic waves 730 are scattered severely.

FIG. 7B shows a result of a pattern simulation of a pressure field of waves when metamaterials according to an embodiment of the present inventive concept are disposed around the solid plate 720 of FIG. 7A. The metamaterials of FIG. 7B may be formed by disposing the two-dimensional artificial atoms in two dimensions.

As illustrated in FIG. 7B, the scatterer solid plate 720 may be enclosed by metamaterials 740. In both simulations, a frequency of the incident wave 730 within the waveguide 710 is a frequency ωa/(2πc)=214, which is smaller than the frequency of the lower edge of the band gap where the relative effective density is zero. The small relative effective density _{ρr}=−0.1 together with the large relative bulk modulus _{Br}=−33 implies the occurrence of tunneling. In FIG. 7B, it was confirmed that the plane waves may be maintained without scattering when passing through the solid plate 720 enclosed by the metamaterials.

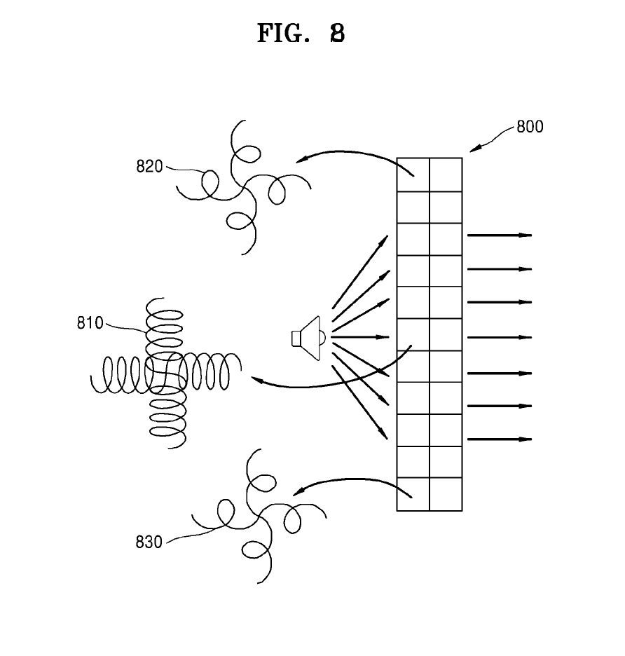

FIG. 8 is a view illustrating a lens formed of metamaterials according to an embodiment of the present inventive concept.

As illustrated in FIG. 8, a lens 800 may be formed by disposing a plurality of two-dimensional artificial atoms 810, 820, and 830 in two dimensions. The two-dimensional artificial atom 810 with a large degree of coiling units may be disposed at the center of the lens 800, and other two-dimensional artificial atoms 820 and 830 of which a degree of coiling units decreases toward the edge of the lens 800 may be disposed at the edges. Thus, a plurality of two-dimensional artificial atoms in which a degree of coiling units gradually changes from the center to the edges of the lens 800 may be formed. The lens 800 may have a refractive index gradually changing from the center to the edges of the lens 800.

The above-mentioned metamaterial controls not only acoustic waves, but also elastic waves or electromagnetic waves. Therefore, a device changing the characteristics of elastic waves or electromagnetic waves may be manufactured by the metamaterial.

It should be understood that the exemplary embodiments described therein should be considered in a descriptive sense only and not for purposes of limitation. Descriptions of features or aspects within each embodiment should typically be considered as available for other similar features or aspects in other embodiments.

1. A coil-based artificial atoms of metamaterial, comprising:
a first coiling unit that coils up a first space; and
a second coiling unit that coils up a second space and that is connected with the first coiling unit.

2. The coil-based artificial atoms of metamaterial of claim 1, wherein a wave in at least one of the first and second coiling units propagates along a zigzag path.

3. The coil-based artificial atoms of metamaterial of claim 2, wherein at least one of the first and second coiling units is formed by connecting a plurality of channels in series where the wave propagates.

4. The coil-based artificial atoms of metamaterial of claim 3, wherein wave propagation directions of the neighboring channels in the plurality of channels are different.

5. The coil-based artificial atoms of metamaterial of claim 3, wherein the neighboring channels of the plurality of channels are separated by one plate.

6. The coil-based artificial atoms of metamaterial of claim 3, wherein the plurality of channels are narrow in width in comparison to a wavelength of the wave.

7. The coil-based artificial atoms of metamaterial of claim 3, wherein the channel of the first coiling unit and the channel of the second coiling unit are connected to each other in series.

8. The coil-based artificial atoms of metamaterial of claim 1, wherein the wave is at least one of an acoustic wave, an electromagnetic wave, and an elastic wave.

9. The coil-based artificial atoms of metamaterial of claim 1, wherein at least one of the first and second coiling units coil up the space in at least one of two or three dimensions.

10. The coil-based artificial atoms of metamaterial of claim 1, wherein the first and second coiling units are rotationally symmetric about the point connecting the first and second coiling units to each other.

11. The coil-based artificial atoms of metamaterial of claim 1, wherein the first and second coiling units are anisotropic.

12. The coil-based artificial atoms of metamaterial of claim 1, wherein the first and second coiling units are isotropic.

13. The coil-based artificial atoms of metamaterial of claim 1, further comprising a third coiling unit that coils up a third space and that is connected with the first and second coiling units; and a fourth coiling unit that coils up a fourth space and that is connected with first to third coiling units.

14. The coil-based artificial atoms of metamaterial of claim 13, wherein the first to fourth coiling units are interconnected to each other based on the center of the artificial element.

15. The coil-based artificial atoms of metamaterial of claim 13, wherein the artificial element is isotropic.

16. The coil-based artificial atoms of metamaterial of claim 13, wherein a refractive index is proportional to the length of the wave propagation.

17. The coil-based artificial atoms of metamaterial of claim 16, wherein the refractive index is 4 or more.

18. The coil-based artificial atoms of metamaterial of claim 13, wherein at least one of the effective density and effective bulk modulus with regard to the wave of a specific frequency band is negative.

19. The coil-based artificial atoms of metamaterial of claim 13, wherein the refractive index with regard to the wave of a specific frequency band is negative.

20. The coil-based artificial atoms of metamaterial of claim 13, wherein a lattice constant is smaller than the wavelength of the wave.

21. The coil-based artificial atoms of metamaterial of claim 13, wherein the third and fourth coiling units are rotationally symmetric based on the point connecting the third and fourth coiling units to each other.

22. The coil-based artificial atoms of metamaterial of claim 1 further comprising a third coiling unit that coils up a third space and that is connected with the first and second coiling units,
wherein the first to third coiling units are rotationally symmetric to each other about the center of the artificial element, and the effective wave propagation direction in each of the first to third coiling units does not exist on the two dimensional plane.

23. A metamaterial formed of a plurality of any of the coil-based artificial atoms of metamaterial of claim 1.

24. The metamaterial of claim 23, wherein the plurality of the artificial atoms are formed in at least one of one dimension, two dimensions, and three dimensions.

25. A device comprising the metamaterial of claim 23, the device changing the characteristics of the incident wave by the metamaterial.

26. An coil-based artificial atoms of metamaterial comprising:
an inlet for an incident wave;
an outlet for wave rejection; and
a coiling unit wherein space is coiled up and the waves move along a ziazag path toward the outlet.

27. The coil-based artificial atoms of metamaterial of claim 26, wherein the coiling unit is formed by connecting a plurality of channels in series where the incident waves propagate through.

28. The coil-based artificial atoms of metamaterial of claim 27, wherein a sum of the propagation directions of the plurality of channels are consistent with the propagation directions from the inlet to the outlet.

29. The coil-based artificial atoms of metamaterial of claim 26, wherein a refractive index of the metamaterial structure is proportional to a length of the pathway of the wave propagation in the coiling unit.

30. An coil-based artificial atoms of metamaterial comprising:
an inlet for an incident wave;
an outlet for wave rejection; and
a coiling unit that is connected from the inlet to the outlet and guides the movement of the waves,
wherein a length of the wave propagation in the coiling unit is longer than a straight-line distance between the inlet and the outlet.
